(19) United States
(12) Patent Application Publication
(10) Pub. No.: US 2009/0272624 A1
(43) Pub. Date: Nov. 5, 2009

(54) CONVEYOR ASSEMBLY WITH AIR ASSISTED SORTING

(75) Inventors: Thomas Edwards, Newaygo, MI (US); Jason Perks, Grand Rapids, MI (US)

Correspondence Address: MILLER, CANFIELD, PADDOCK AND STONE;ROBERT K. ROTH, ESQ., 150 W. JEFFERSON, SUITE 2500, DETROIT, MI, 48226, US

(73) Assignee: Blesco, Inc., Grand Rapids, MI (US)

(21) Appl. No.: 12/432,936

(22) Filed: Apr. 30, 2009

Related U.S. Application Data
(60) Provisional application No. 61/049,119, filed on Apr. 30, 2008.

(51) Int. Cl. B65G 47/46; B07C 5/00

(52) U.S. Cl. 198/370.11; 209/552

(57) ABSTRACT

A conveyor assembly for sorting a plurality of objects comprises a conveyor belt having a surface with a first end and a second end, adapted to carry the plurality of objects from the first end toward the second end, and an electric motor adapted to move the conveyor belt. At least one air flow generation device is positioned adjacent the conveyor belt, and a controller sends a signal to the air flow generation device to generate air flow adapted to bias at least one of the plurality of objects off the conveyor belt.

### RELATED APPLICATION

This application claims priority benefit of U.S. provisional patent application No. 61/049,119 filed on Apr. 30, 2008.

### FIELD OF THE INVENTION

This invention relates to conveyor assemblies, and more particularly to conveyor assemblies with improved ability to separate objects of varying weights, shapes and sizes.

### BACKGROUND OF THE INVENTION

Conveyor assemblies are used in a wide variety of material handling applications, from transportation of products from one place to another to sorting of products. Many conveyor assemblies use electric motor driven conveyor belts in manufacturing, distribution, and other applications where the products that need to be sorted may be corrugated boxes, poly bags, or other products. Examples of such conveyor assemblies used for sorting having a conveyor belt include, for example, so-called high speed wheel sorters, where the products to be sorted are transported along a belt until they reach a divert point. At the divert point, angled wheels are lifted, biasing the product off the belt. Such a design is difficult to use with products which are very light, such as poly bags. Light products can fall between the wheels and/or not always make solid contact with the wheels to ensure proper diversion off the belt.

Another known design is the so-called sliding shoe sorter. In this sorting technology, the products are conveyed on slats to the divert point, whereupon solid “shoes” push a product off the slats. Although such designs are useful for sorting poly bags, occasionally such bags can get stuck on the shoes. Further, the transitions on and off the slats can be difficult for the bags to navigate. Also, such known designs are relatively expensive.

One other known design in sorting technology is sometimes referred to as the tilt tray/cross belt sorter. With tilt tray/cross belt sorters, products are placed on a tray or a cross belt At the point of divert the tray is tilted, and product will slide off. The cross belt activates a belt which conveys the product off the sorter. This is an effective method of sortation, but is an extremely expensive solution and is generally not cost effective for many types of sorting applications. Thus, there is a need for a conveyor assembly that can properly convey and sort poly bags, small and light corrugated cartons, and/or a combination of poly bags and corrugated cartons, all preferably without the use of diverters and which can be made at reasonable cost.

### SUMMARY OF THE INVENTION

In accordance with a first aspect, a conveyor assembly for sorting a plurality of objects comprises a conveyor belt having a surface with a first end and a second end, adapted to carry the plurality of objects from the first end toward the second end, and an electric motor adapted to move the conveyor belt. At least one air flow generation device is positioned adjacent the conveyor belt, and a controller sends a signal to the air flow generation device to generate air flow adapted to bias at least one of the plurality of objects off the conveyor belt.

From the foregoing disclosure and the following more detailed description of various preferred embodiments it will be apparent to those skilled in the art that the present invention provides a significant advance in the technology and art of conveyor assemblies. Particularly significant in this regard is the potential the invention affords for providing a high quality, low cost, conveyor assembly adapted for separation of relatively lightweight objects. Additional features and advantages of various preferred embodiments will be better understood in view of the detailed description provided below.

### BRIEF DESCRIPTION OF THE DRAWINGS

FIG. 1 is an isometric view of a conveyor assembly in accordance with one embodiment.

FIG. 2 is an isolated isometric view of a representative air flow generation device.

FIG. 3 is a partial schematic top view of the conveyor assembly of FIG. 1, with a plurality of varying objects placed on the surface of a conveyor belt.

FIG. 4 is another top view showing adjustability of the air flow generation device.

FIG. 5 is a side view of a portion of the conveyor assembly.

FIGS. 6-8 are top side schematic views of the conveyor assembly, shown in operation sorting an object into one of the chutes.

FIG. 9 is an alternate embodiment showing a sensor positioned near a first end of the conveyor belt.

It should be understood that the appended drawings are not necessarily to scale, presenting a somewhat simplified representation of various preferred features illustrative of the basic principles of the invention. The specific design features of the conveyor assembly as disclosed here will be determined in part by the particular intended application and use environment. Certain features of the illustrated embodiments have been enlarged or distorted relative to others to help visualization and clear understanding. In particular, thin features may be thickened, for example, for clarity of illustration. All references to direction and position, unless otherwise indicated, refer to the orientation illustrated in the drawings.

### DETAILED DESCRIPTION OF CERTAIN PREFERRED EMBODIMENTS

It will be apparent to those skilled in the art, that is, to those who have knowledge or experience in this area of technology, that many uses and design variations are possible for the conveyor assembly disclosed here. The following detailed discussion of various alternative and preferred features and embodiments will illustrate the general principles of the invention with reference to a conveyor assembly suitable for use in separating boxes, poly bags and similar products. Other embodiments suitable for other applications will be apparent to those skilled in the art given the benefit of this disclosure.

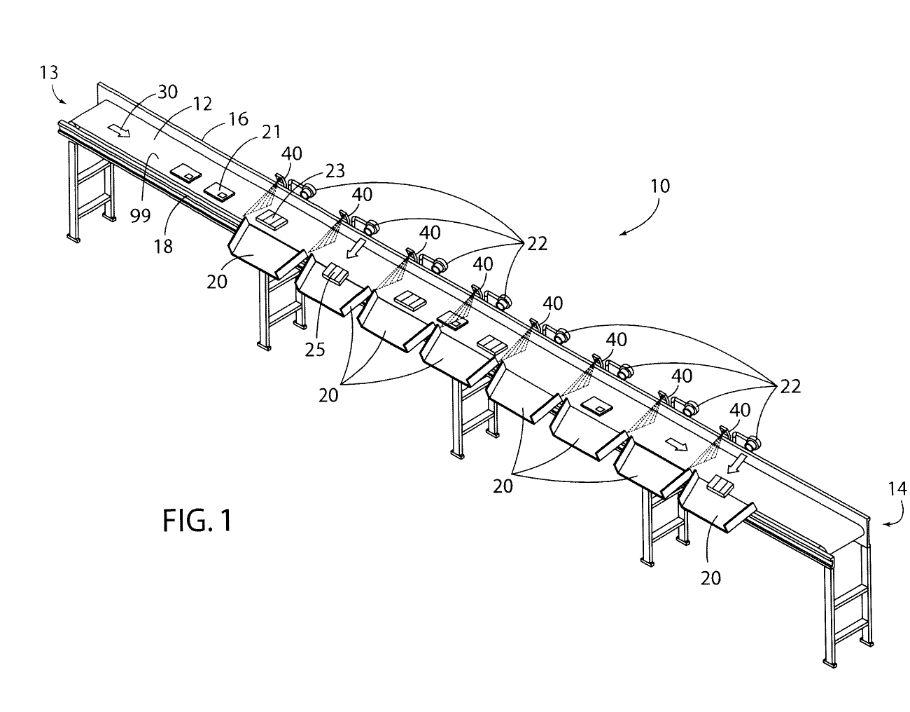

Turning now to the drawings, FIG. 1 shows a conveyor assembly 10 in accordance with one embodiment. A conveyed stream or plurality of objects 21, 23, 25 of varying sizes, shapes and mass travel on a surface 99 of a conveyor belt 12. The conveyor belt 12 can be part of a commercially available transportation, accumulation or conveyor belt assembly such as an activated roller belt (“ARB”) conveyor with conveying surface 99 with rollers, PVC belting, or plastic belting, for example. Conveyor belt preferably rotates in a continuous loop in response to rotation of an electric motor and moves the plurality of objects 21, 23, 25 from a first end 13 of the belt 13 and toward a second end 14. The surface 99 can be considered a horizontal surface, and items extending above surface 99, such as the side walls 16, 18, extend vertically away from the surface. First side wall 16 and second side wall 18 are positioned adjacent the conveyor belt 12. The side walls 16, 18 cooperate to help captivate the plurality of objects 21, 23, 25 as they travel along the conveyor belt 12.

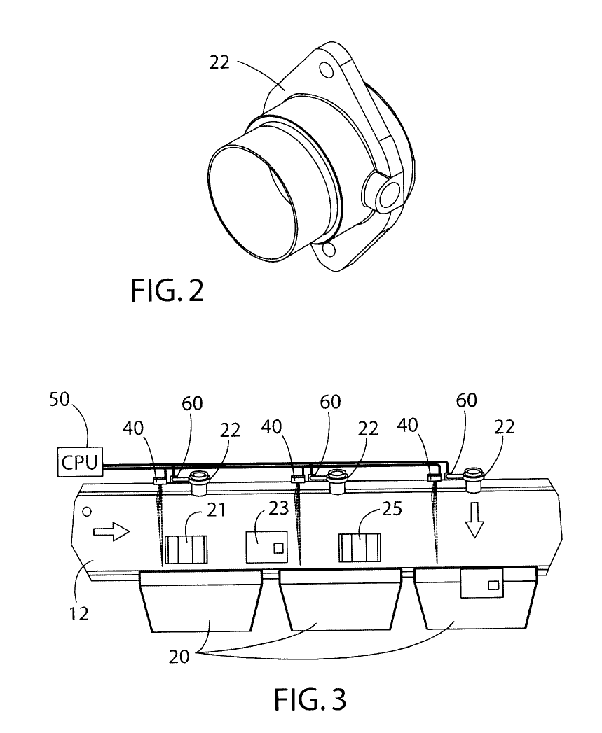

In accordance with a highly advantageous feature, the plurality of objects 21, 23, 25 are diverted from the conveyor belt using a combination of the conveyor belt with air by an air flow created by an air flow generation device, or using air flow alone. The air flow generation device 22 can be a fan or blower, but more preferably is an air amplifier, such as those manufactured by Exair Corporation. FIG. 2 shows a representative air amplifier. Air amplifiers are relatively small, easy to install, and take energy from a small volume of compressed air and produce a high velocity, high volume, low pressure output air flow. Such air amplifiers can be mounted on the conveyor belt, or immediately adjacent the conveyor belt, as required. As shown in FIG. 1, optionally a plurality of air amplifiers may be used, optionally in conjunction with a corresponding chute 20. Air flow from the air amplifier 22 biases the object or objects off the conveyor belt and into the chute. The electric motor powered conveyor belt 12 is preferably used in combination with one or multiple air amplifiers 22 to create an overall conveyor assembly that can successfully and predictably convey and sort a broad range of standard sized corrugated boxes, small and light products, and poly bags. Other arrangements and types of air flow generation devices and chutes will be readily apparent to those skilled in the art given the benefit of this disclosure.

As noted above, the powered conveyor belt 12 is provided with output destination conveyor lanes, hoppers or chutes 20 properly positioned. As shown in the Figs., such as in FIG. 1, the conveyor belt is positioned between an air amplifier 22 and a chute 20. The chutes 20 are formed or positioned in side wall 18. See also FIG. 5 which shows the chute extending below the surface 99 of the conveyor belt, the belt 12 forming a continuous loop and the belt mounted on support 80. Thus, during sorting, air flow blows at least one of the objects off the conveyor belt and into the chute, where gravity completes the process.

In accordance with a highly advantageous feature, a controller 50 may be operatively connected to the air flow generation devices and capable of sending a signal, a control signal to the air flow generation device(s) at the appropriate time to provide air flow sufficient to bias one or more of the plurality of objects off the conveyor belt. The controller initiates the process by sends a signal to provide power to the conveyor belt and thereby move the objects along the belt. An object sort is attempted by sending a signal to the appropriate air amplifiers to blow objects into the chute. The air amplifiers are installed and situated so as to become energized and blow a stream of air at the object to be sorted at an appropriate time. Such air amplifiers advantageously aid the traditional sorter mechanism and/or allow for sorting the object with the air amplifier alone. The activation of the air amplifier can be through PLC/PC controls to an air valve, or piloted off of the activation for a conveyor belt divert mechanism, when present. The timing of the activation is done using sorter tracking logic or activated off of a sensor.

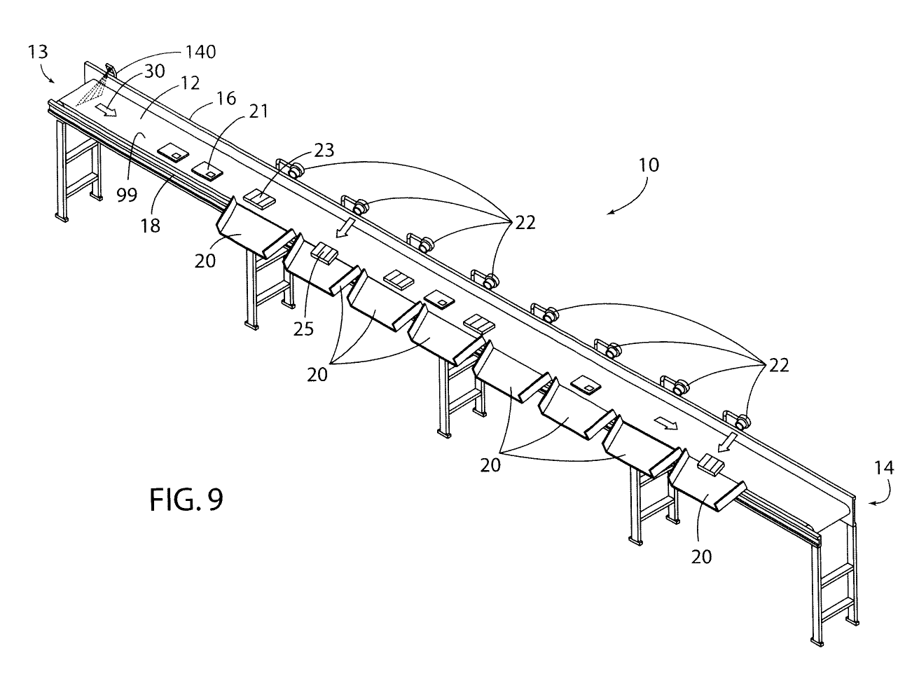

FIG. 3 shows the diverting action, with multiple objects tracked using sensors 40 and sorted with the air amplifiers 22. With a divert command activated, air flow or a blast from the air amplifier 22 with move the objects to chute 20 in a direction generally perpendicular to the direction of travel of the objects along the conveyor belt 12. FIGS. 3-4 and 6-8 show an embodiment where a sensor is positioned generally adjacent each air flow generation device. The sensor senses movement of the plurality of objects as they pass by the sensor on the conveyor belt, and sends a sensor signal to the controller indicating its status. In accordance with another embodiment, a sensor 140 can be positioned along the conveyor belt near the first end 13 and prior to the air flow generation devices 22, as is shown in FIG. 9. Since the position of the sensor is known, the position of the air amplifiers is known and the rate of travel of the objects along the conveyor belt is known, the amount of time until any object travels from the sensor 140 to the chute 20 can be calculated by the controller 50. In a manner similar to the previous embodiment, the sensor 140 would send a sensor signal to the controller 50 indicating the presence of objects to be sorted passing by the sensor on the conveyor belt. In response, the controller would calculate the time before the object would pass by a particular air amplifier, and at the appropriate time, send the control signal to the air flow generation device to provide air flow to blow one or more of the objects off the conveyor belt and into the chute.

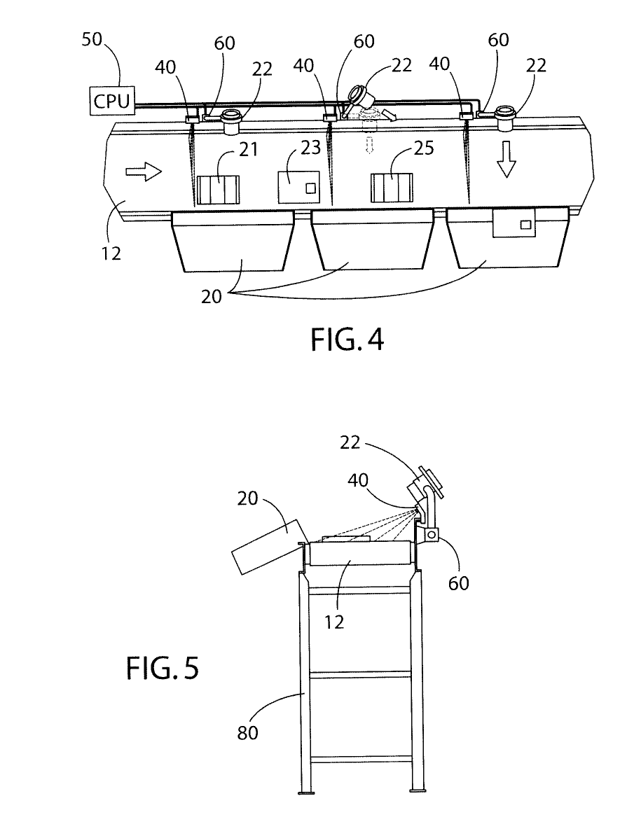

Advantageously, the air amplifier 22 can be adjustable with respect what it is mounted to, as is shown in FIG. 4. This is useful where the properties of the objects to be sorted varies. The air amplifier 22 can be adjusted at pivot or fitting 60, for example, to deliver air blasts at various angles. FIG. 4 shows adjustments that can be made to the air amplifier 22 by rotating the air fittings 60 to change the horizontal angle of the air blast or flow. This adjustment will allow for proper sorting at a range of conveying surface speeds. FIG. 5 shows air fittings 60 which allow changes the vertical angle of the air blast or flow.

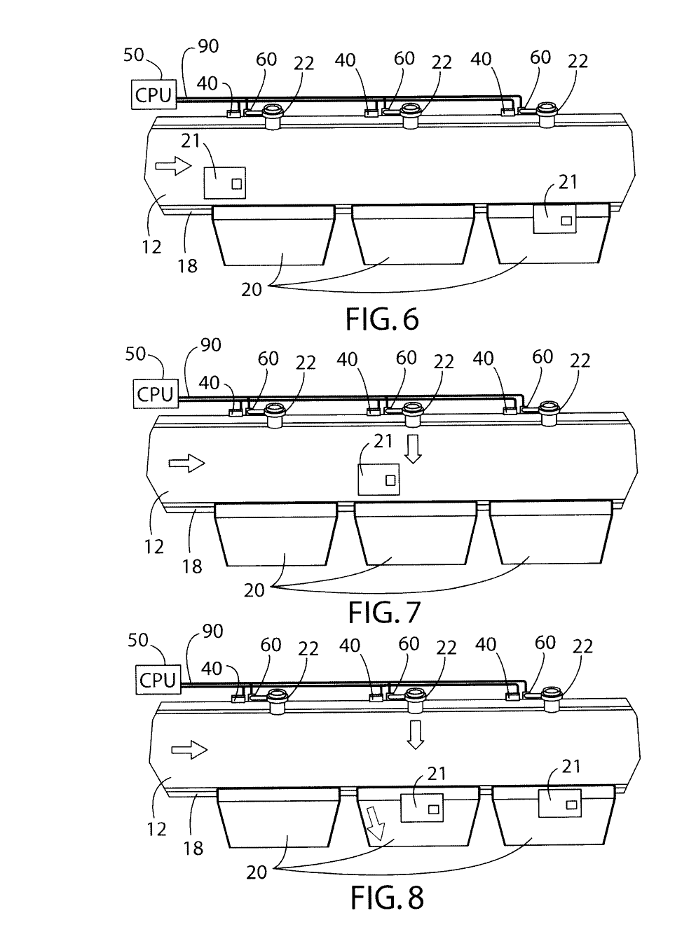

The operation of the conveyor assembly 10 is depicted in FIGS. 6-8. In FIG. 6 an object 21 shown conveyed in the direction of travel on conveyor belt 12. Object 21 is located at the point of activating the air amplifier 22 to divert down chute 20. In FIG. 7 at the time that the object 21 is at a divert location, air amplifier 22 is activated sending an air blast or flow across the conveyor belt 12 that contacts the object 21. In FIG. 8 the air flow continues while the object 21 is in front of the air amplifier 22, pushing the object 21 off of the conveyor belt 12 and down the divert chute 20. Signals are sent to and from the controller via electrical connections 90.

As can be seen herein, the conveyor assembly with air flow generation device provides an advantageous method of sorting a plurality of objects comprising the steps of carrying the plurality of objects on a surface of a conveyor belt from a first end of the conveyor belt toward a second end, moving the conveyor belt with an electric motor, generating an air flow using at least one air flow generation device positioned adjacent the conveyor belt, and biasing one or more of the plurality of objects off the conveyor belt with a controller which send a signal to the air flow generation device to generate the air flow. The air flow generation device can be, as noted above, an air amplifier 22, which is adjustable so that a direction of air flow is adjustable, and the air amplifier biases one or more of the plurality of objects to a chute. The objects are sensed using a sensor which sends a sensor signal to a controller indicating the presence of one or more of the plurality of objects and a control signal is sent from the controller to the air flow generation device to provide air flow and bias one or more of the objects off the conveyor belt.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A conveyor assembly for sorting a plurality of objects comprising, in combination:
a conveyor belt having a surface with a first end and a second end, adapted to carry the plurality of objects from the first end toward the second end;
an electric motor adapted to move the conveyor belt;
at least one air flow generation device positioned adjacent the conveyor belt; and
a controller which send a signal to the air flow generation device to generate air flow adapted to bias at least one of the plurality of objects off the conveyor belt.

2. The conveyor assembly of claim 1 wherein the at least one air flow generation device is an air amplifier.

3. The conveyor assembly of claim 2 wherein the air amplifier is mounted on the conveyor belt.

4. The conveyor assembly of claim 2 wherein the air amplifier is adjustable so that a direction of the air flow is adjustable.

5. The conveyor assembly of claim 2 further comprising at least one chute positioned on the conveyor belt, wherein the air amplifier biases at least one of the plurality of objects to the at least one chute.

6. The conveyor assembly of claim 5 wherein the at least one chute comprises a plurality of chutes, with each chute having a corresponding air amplifier.

7. The conveyor assembly of claim 5 wherein the conveyor belt is positioned between the air amplifier and the at least one chute, and the generation of air flow urges at least one of the plurality of objects off the surface of the conveyor belt and on to the chute.

8. The conveyor assembly of claim 1 wherein the conveyor belt forms a continuous loop.

9. The conveyor assembly of claim 1 further comprising a first side wall and a second side wall, with each side wall positioned adjacent the conveyor belt, wherein the side walls help captivate the plurality of objects on the conveyor belt.

10. The conveyor assembly of claim 9 wherein at least one chute is formed in one of the side walls, allowing at least one of the plurality of objects to leave the surface of the conveyor belt and travel to the chute in response to air flow generated by the air flow generation device.

11. The conveyor assembly of claim 1 wherein the plurality of objects travel on the conveyor belt and are sorted in a controlled manner by the controller sending a signal to the at least one air flow generation device at an appropriate time to provide air flow sufficient to separate a particular object from the plurality of objects carried along the conveyor belt from the conveyor belt.

12. The conveyor assembly of claim 11 further comprising a sensor positioned generally adjacent each at least one air flow generation device, adapted to sense movement of the plurality of objects as they pass by the sensor on the conveyor belt.

13. The conveyor assembly of claim 12 wherein the sensor sends a sensor signal to the controller indicating the presence of at least one of the plurality of objects and the controller sends a control signal to the air flow generation device to initiate air flow and blow the at least one of the plurality of objects off the conveyor belt.

14. The conveyor assembly of claim 11 further comprising a sensor positioned along the conveyor belt between the first end and one of the at least one air flow generation devices, wherein the sensor is adapted to sense the presence of the plurality of objects as they pass by the sensor on the conveyor belt.

15. The conveyor assembly of claim 14 wherein the sensor sends a sensor signal to the controller indicating the presence of at least one of the plurality of objects and the controller sends a control signal to the air flow generation device to provide air flow at an appropriate time to blow the at least one of the plurality of objects off the conveyor belt.

16. A method of sorting a plurality of objects comprising, in combination, the steps of:
carrying the plurality of objects on a surface of a conveyor belt from a first end of the conveyor belt toward a second end;
moving the conveyor belt with an electric motor;
generating an air flow using at least one air flow generation device positioned adjacent the conveyor belt; and
biasing at least one of the plurality of objects off the conveyor belt with a controller which send a signal to the air flow generation device to generate the air flow.

17. The method of claim 16 wherein the air flow generation device is an air amplifier, which is adjustable so that a direction of air flow is adjustable, and further comprising at least one chute, wherein the air amplifier biases at least one of the plurality of objects to the at least one chute.

18. The method of claim 17 further comprising the steps of
sensing at least one of the plurality of objects;
sending a sensor signal to a controller indicating the presence of at least one of the plurality of objects and
sending a control signal from the controller to the air flow generation device to provide air flow and bias the at least one of the plurality of objects off the conveyor belt.
